(19) United States
(12) Patent Application Publication
(10) Pub. No.: US 2006/0132291 A1
(43) Pub. Date: Jun. 22, 2006

(54) Automated vehicle check-in inspection method and system with digital image archiving

(76) Inventors: Charles Dourney JR., Newton, NJ (US); Kenneth Esposito, Sussex, NJ (US)

Correspondence Address: BURNS & LEVINSON LLP, 1030 15TH STREET NW, SUITE 300, WASHINGTON, DC, 20005-1501, US

(21) Appl. No.: 11/270,004

(22) Filed: Nov. 9, 2005

Related U.S. Application Data
(60) Provisional application No. 60/628,905, filed on Nov. 17, 2004.

(51) Int. Cl. H04N 7/18; G09F 25/00

(52) U.S. Cl. 340/286.01; 348/148

(57) ABSTRACT

A collection of software scripts, programs and web pages that capture, organize, and store wireless and digital device data and images of customer/lot vehicles for use in vehicle dealerships, service, and repair locations. Reports and views of the collected, organized data in real-time are provided.

### CROSS REFERENCE TO RELATED APPLICATIONS

This application claims priority under 35 U.S.C. § 119 from provisional application Ser. No. 60/628,905 entitled “Automated Vehicle Check-In Inspection System,” filed Nov. 17, 2004.

### FIELD OF THE INVENTION

The present invention relates to a Data Capture and Image Archiving System directed to the capture, organization and storage of data and digital images, e.g., of vehicles.

### BACKGROUND OF THE INVENTION

Currently, at automobile dealerships around the country, when a new car is delivered, when a customer is dropping off a car for service or retrieving it after service, or when a customer is picking up or dropping off a loaner car, the vehicles are inspected for damage, and the information such as mileage, fuel level and hang tag number are written on a piece of paper. The present antiquated method of vehicle inspection performed by the service department at most car dealerships involves noting on a piece of paper pertinent vehicle information, including any visible body damage. It is nearly impossible for a person to visually inspect a vehicle for damage and not miss something. Practically every vehicle that is dropped off for service has some sort of damage on it. In addition, at automobile rental agencies, documentation of rental unit body damage at check out and check in is a major customer relations and labor usage problem.

The customer may often be unaware of issues like dings and scratches on her vehicle until she comes to pick it up. Suddenly the customer sees a damage element never noticed before and immediately assumes that the dealership is responsible. If the inspector neglected to inspect the car at time of drop off, or if the inspector overlooked the damage, the dealership has no choice but to fix the damage at no charge while the customer drives around in a loaner car. This process becomes increasingly expensive; the company's customer service index suffers, and one of the most unfavorable results is a disaffected customer.

An average dealership can spend from $3,500 to $50,000 per month repairing lot damage. Of that amount, at least half may be due to the failure to inspect a new car, service or loaner car at the time they are dropped off or picked up, lot personnel overlooking damage during inspection, and/or unsubstantiated claims by customers. Documentation of rental unit body damage is also an expensive problem for car rental companies.

Assuming adequate visual documentation, industry statistics indicate that a customer is 80% more likely to approve a repair if they are able to see the problem for themselves. A desirable system would enable the user to e-mail the customer an estimate for repairs including digital images of the issue with the vehicle. Likewise, service advisors could quote and sell repair estimates for problems such as rim repair, “ding” repair, windshield repair, and body shops for more effective estimating and scheduling of repairs. Moreover, digital damage information could be e-mailed automatically to vendors. Images and data could also be forwarded directly to insurance companies to support claim approval.

It is an object of the invention therefore to provide a system that captures, organizes, and stores information regarding vehicles or other movable objects using before and after photographic images for future reference. Yet another object of the invention is to provide high resolution images of vehicles to display the condition and areas of damage on said vehicles and permit zooming. Still another object of the invention is to provide the ability to view captured events and conditions by multiple computers simultaneously using only a wired or wireless local area network, other inhouse computer system, or the internet.

It is yet a further object of the invention to provide a system that can be modified or extended to provide documentation and recall of image and other information regarding: rental equipment condition, car wash pre/post vehicle condition, home inspection pre/post condition, and reconstructive surgery pre/post condition, including, but not limited to dental, plastic surgery, limb replacement, facial reconstruction, and body enhancements such as tattoos, breast augmentation, piercing processes, construction site equipment pre/post condition, and landscape pre/post construction condition.

### SUMMARY OF THE INVENTION

The hardware implementation of the system of this invention typically comprises a high capacity server computer capable of storing large volumes of high-resolution digital images linked to text, input devices comprising, for example, digital cameras or assemblies of digital imaging devices, text input means comprising either handheld text data input devices or devices capable of storing identifying data on RFID tags or barcode stickers, retrievable terminals or other retrievable devices, and wired or wireless networks linking the foregoing. All or part of the linking network optionally operates over the internet.

Utilizing a text data input device, preferably wireless, and a digital camera, the AutoCheckMate™ (ACM) system captures and stores for future use relevant information and images of damage to, e.g., a motor vehicle. If a vehicle's condition is questioned at any time during or after a service visit, a user is able to retrieve quickly high-resolution digital images, zoom in on the area in question, and verify responsibility therefor. Captured events may be viewed by multiple computers at the same time using optionally an internet connection.

The present invention uses digital images to capture all desirable angles of the vehicle. If the customer asserts that there is damage to the vehicle that was not present when the vehicle was dropped off or picked up, the dealership's service representatives are able to quickly retrieve the vehicle check-in and vehicle check-out pictures. By zooming in on the area in question, it can easily be determined whether the customer or the dealership is responsible for the damage.

### BRIEF DESCRIPTION OF THE DRAWINGS

FIG. 1 is a schematic of the overall operation of the system envisioned in the invention.

FIG. 2 shows an example of a vehicle identification screen in accordance with the implementation of the present invention on a handheld computer or personal digital assistant.

FIG. 3 is an example of a main menu screen in accordance with the implementation of the present invention on a handheld computer or personal digital assistant.

FIG. 4 is an example of a vehicle information entry screen in accordance with the implementation of the present invention on a handheld computer or personal digital assistant.

FIG. 5 is an example of a vehicle damage entry screen in accordance with the implementation of the present invention on a handheld computer or personal digital assistant.

FIG. 6 is an example of a vehicle damage entry screen with a display of the view menu in accordance with the implementation of the present invention on a handheld computer or personal digital assistant.

FIG. 7 shows an example of a vehicle damage entry screen with a display of the damaged part menu in accordance with the implementation of the present invention on a handheld computer or personal digital assistant.

FIG. 8 shows an example of a vehicle damage entry screen with a display of the damage type menu in accordance with the implementation of the present invention on a handheld computer or personal digital assistant.

FIG. 9 shows an example of a vehicle damage entry screen with a display of the severity menu in accordance with the implementation of the present invention on a handheld computer or personal digital assistant.

FIG. 10 is an example of a note entry screen in accordance with the present invention.

FIG. 11 is an example of a screen shot of a vehicle summary screen in accordance with the implementation of the present invention on a web browser.

FIG. 12 is an example of a screen shot of a vehicle identification number search screen in accordance with the implementation of the present invention on a web browser.

FIG. 13 is an example of a screen shot of an image capture date search in accordance with the implementation of the present invention on a web browser.

FIG. 14 is an example of a screen shot of a damage summary screen in accordance with the implementation of the present invention on a web browser.

FIG. 15 is an example of a screen shot of a detailed vehicle information screen in accordance with the implementation of the present invention on a web browser.

FIG. 16 is an example of a screen shot of a vehicle check-in detail screen in accordance with the implementation of the present invention on a web browser.

FIG. 17 is an example of a screen shot of a viewing screen for a captured vehicle image in accordance with the implementation of the present invention on a web browser.

FIG. 18 is an example of a screen shot of an electronic mail message screen in accordance with the implementation of the present invention on a web browser.

FIG. 19 is an example of a screen shot of a notification summary screen in accordance with the implementation of the present invention on a web browser.

FIG. 20 is an example of a screen shot of a notification detail screen in accordance with the implementation of the present invention on a web browser.

### DETAILED DESCRIPTION OF THE PREFERRED EMBODIMENTS

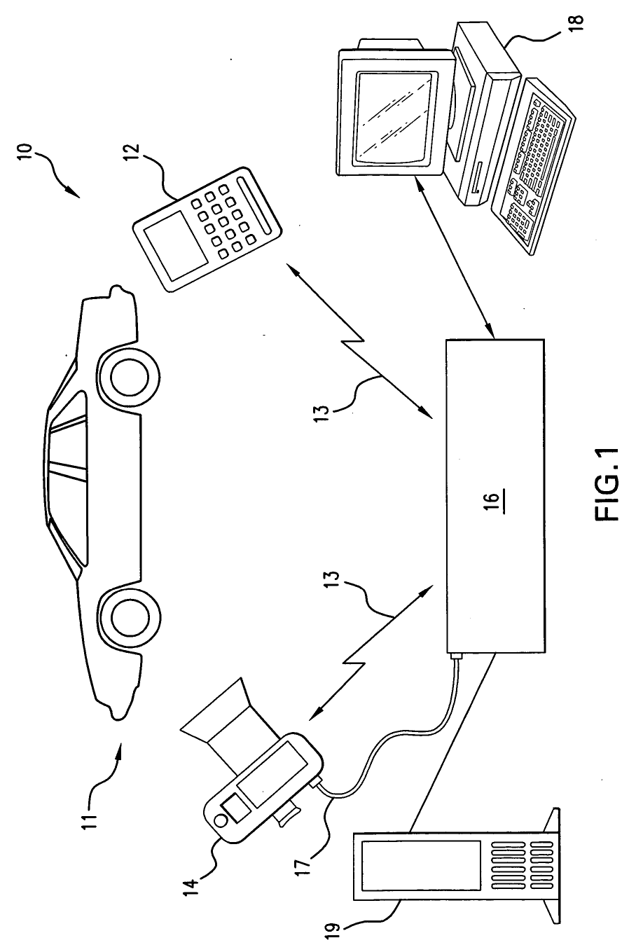

A schematic diagram of an exemplary embodiment 10 of a system according to the invention is illustrated in FIG. 1. The Automated Vehicle Inspection System 10 is designed to capture and organize data and digital images of a vehicle 11 for future recall and reference. The three main components used in the process are a textual data input device 12 such as a hand-held and/or wireless data input device, e.g., a personal digital assistant (PDA), an image data input device 14 such as a high-resolution digital camera (it is to be understood that the depiction of a single camera in this Figure is schematic only, and the single camera can be replaced in the system by a plurality of cameras or, for example, a specialized stand-alone drive-through damage imaging station), and a computer server 16 capable of storing the data and images, together with software, typically off the shelf but customized, to manage the data.

Communication between the components can be facilitated, for example, with a wireless local area network (LAN) infrastructure 13 between the server 16 and text data input device unit 12. Optionally the network can be wired. The camera 14 preferably also communicates with the server 16 via the wireless network 13, or it may communicate with the server 16 by transfer of images using a universal service bus (USB) cable 17 or camera docking station 19. LAN workstations 18 can recall the stored data, e.g, from the server, or data can be recalled on any networked PC and optionally on a remote computer, e.g., that of a customer, using in whole or in part an internet connection.

Exemplary hardware that can be used to implement the invention could be, for example, a high capacity server computer with, for example, an internal 250 gigabyte hard drive for image and data storage, a Wi-Fi capable hand-held text data input device unit, a multi-mega-pixel digital camera with a docking station or network link, and a backup archiving system comprising, e.g., a mirror drive or a tape backup system. Alternatively, an existing high-capacity dealership server computer can be used as the image and data storage unit for the current invention. In yet another alternative, in this implementation the dealership server serves as a local storage unit that is interconnected to a publicly accessible internet server (see below).

When images are transferred to memory, the server 16 records the time and date of the camera 14 to synchronize image capture with other text data captured by the wireless input device (e.g., the text data input device 12). Also after image transfer, the server instructs the digital imaging device (or devices) to reset, that is, erase internal memory, to ready the image collection devices for a new imaging session.

The system server runs a web-based collection of custom designed pages, using ASP, Windows Script Host and VBscript programs to process incoming images, to archive vehicle identification and condition information, and to serve up recalled dynamic pages which collect all of the information in a set of web display pages for the user. Images are stored on a local server, data is stored in local and remote databases. All data is backed up by a DVD burner integrated with the local server package.

In a typical implementation at an automobile dealership, dealer personnel use tags called hang-tags to aid in tracking vehicles. Hang-tags are identifying numeric cards that hang from the rear view mirror holder in the vehicles, placed by a check-in lot employee. When a vehicle arrives for service, the dealership will create a work repair order (RO) detailing what needs to be done to the vehicle. The RO includes information on the customer name, VIN, vehicle description and history in some cases, requested work, and a dealer assigned temporary ‘tag’ number used to identify the vehicle by sight when it is parked in the lot. The tag numbers are assigned by the service writer who picks from a stack of unassigned dealer tags when he/she is creating the RO. In one sub-embodiment the tags are not reusable and are disposed of after use.

Some dealerships have tag or ID numbers also painted on specific parking spaces in the lot. When a mechanic goes out to find a car to be worked on, he can look at the tag hanging on the vehicle mirror, visible through the window, or he can find the parking spot associated with the tag number found on the RO. The tag has a unique number temporarily assigned to the vehicle to be serviced. Once a vehicle is picked up, the tag is returned to the service writer to be used again on a different service vehicle.

The system of the current invention requires one of two items to be added to the existing tag, either a barcode sticker, with a barcode representation of the existing tag number, or an RFID identifier. The RFID identifier has a unique number assigned to it. An RFID identifier responds with its unique number whenever a RFID transponder interrogates it. The RFID transponder is positioned in the ‘capture zone’ (see below). When a vehicle is positioned to have images captured, the RFID code is read from the tag hanging in the vehicle. If a barcode is used instead, a bar code reader is used at the capture zone point to manually scan the tag, which will capture and store the bar coded tag number. In one alternative embodiment identifying data about the vehicle alternatively entered by handheld device can be pre-stored in and retrieved from the RFID or captured in additional bar-code labels affixed to the hang tag.

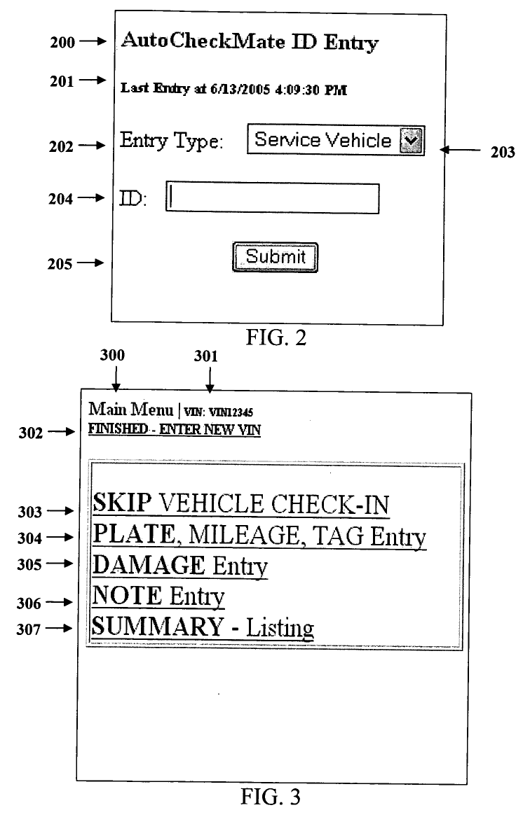

In the embodiment using a handheld device for data input, the textual data input device 12 (e.g., a wireless text data input device) calls up forms and pages from the local web server 16 and allows the device user to ‘walk through’ form prompts to enter data as shown in FIGS. 2 through 4 into the screen on the input device. Once the forms are submitted, i.e., saved to the server 16, the data is time-stamped.

It is central to operation of the invention that the system be able to time and date stamp the images it acquires uniquely, that the time and date stamp correlate very closely with “real world” time, and that the software used to implement the invention is able to sort, collate, or associate data (textual and image) based on that time and date information. Date and time synchronization between the camera and system server is essential to coordination of text data input device data capture events and digital images and to verification of the origin of damage.

A local server script, running at a pre-programmed time, processes image details, image metadata, and other data. In standard operation, the script opens a local server database and creates new database records containing the image name, location, data and time of capture, and other metadata information to be used in future recall. In one sub-embodiment, whenever the camera docking station send function is activated a synchronization between the system server clock and the internal digital camera clock occurs. In another embodiment, camera time does not irrevocably dominate. Different sub-embodiments can use either the digital imaging device internal time or the local server time. Another sub-embodiment would be to use an external time obtained, for example, via the internet. Conflicts between the camera initiated time-date stamp and the internal time-date stamp of the server or internet time can be resolved through preexisting priorities established at the initiation of the system and/or in the script. Once the script has finished its pass thorough the new images, the script updates a control file with log entries and last date and time of run.

The operator can also enter specific damage ‘events’ or issues in text form as the vehicle is photographed or otherwise initially processed. Although text damage issue entry is not mandatory, redundancy and corroboration are useful. Additional forms on the input device are used to capture these text versions of the condition of the subject vehicle. The input forms, as shown in FIGS. 5 through 11, typically use custom questions and responses determined and programmed during initial system setup. The wireless input device 12 communicates with and identifies itself to the local server (alternatively a web server) 16 through query string variables which are sent and recalled with each page refresh or submittal.

Once wireless data input capture has begun, the device operator uses the digital camera 14 (it is to be understood throughout that the reference to “camera” is intended to encompass plural cameras capturing related images more or less simultaneously) to capture at least one image of the vehicle 11. The at least one image is time/date stamped by the camera and system software, and image data variables are saved in each image in the image ‘metadata’—a collection of internal, typically inaccessible data fields of information stored by default with each digital image. The digital images are transferred to the local server optionally by way of cable, digital camera dock, or via the wireless connection.

The script causes the server to process new digital images that have been saved to the local server 16 since the last script run. The script opens each digital image and examines the metadata fields stored in the image. Further processing of the information takes place as preprogrammed as previously outlined.

In order to catalog the images properly, a vehicle ID, preferably the last seven digits of the unique vehicle identification number (VIN), must be entered using the text data input device 12 in the same time frame that images are captured with the camera for each vehicle. In the simplest embodiment, a user enters the vehicle ID using the ID Entry screen before collection of images on each vehicle.

Several alternative methods and apparatus exist for entering into the database some of the basic information called for in the entry windows of FIGS. 2 through 4. FIG. 2 illustrates an example of an ID Entry screen as displayed on a user's text data input device. The heading “AutoCheckMate ID Entry” 200 is visible at the top portion of said screen. Feature 201 displays the time (e.g. 4:09:30 PM) and date (e.g. 6/13/2005) of the last entry entered by the user. In Entry Type 202, the user selects from a pull-down menu 203 the type of vehicle (e.g. service vehicle) checked into the dealership site. The VIN or other vehicle ID is entered in field 204.

The user then submits the data via screen button 205. An alternate mode of entering, inter alia, VIN information is to use radio frequency identification (RFID) tags temporarily located within the vehicles (as noted above) as they check in or out and a location mounted RF transceiver-reader. (RFID is an automatic item identification technology relying on storing and remotely retrieving data from tags containing printed radio-frequency antennas connected to small computer storage chips. RFID tags receive and respond to radio-frequency queries from an RFID transceiver.) RFID tags on which information extracted from the repair order is stored are read and stored in the server. The RFID subsystem can provide data to the database in place of much of what would have been entered by hand according to FIGS. 2 through 4. Alternatively, barcode technology can be implemented in place of RFID. For the barcode version, a wireless barcode scanner is used to read and send to the server information affixed to the hang tag.

Images are optionally collected and temporarily stored on an internal memory card within the camera. Images are transferred to permanent storage, for example, by means of a camera dock, network link, or wirelessly depending on the cameras. Once images are transferred to the server, they are removed from the camera. In one sub-embodiment, at this time the camera date and time are synchronized to the server's date and time.

The server optionally interrogates the camera port for new incoming images in an approximately 60-second cycle. When new images are detected, the server organizes text data input device event data and images to attach the correct images to the correct vehicle IDs 204, as entered by the check-in person. Data management software optionally organizes, sorts, and optimizes storage of stored data. In the current embodiments, images and data are typically available for review on any connected workstation or handheld in less than 60 seconds.

In the handheld data input mode, all text data input device screens are identified in the upper left-hand screen corner. FIG. 3 illustrates the Main Menu icon 300 in the upper left-hand screen corner. The current vehicle ID number is listed as feature 301 along with links to enable navigation to different entry pages. The user chooses from various menu options to enter additional vehicle damage on other screens. The ‘FINISHED—ENTER NEW VIN’ link 302 is selected only when the user has completed entering all vehicle ID and damage information. Digital image capture, as described heretofore, can begin as soon as the text data input device displays this menu, or at any time until the next ID number is entered. If the vehicle cannot be checked-in, the user selects the ‘SKIP VEHICLE CHECK-IN’ link 303 to end the capture session. This returns the user to the ID Entry screen illustrated in FIG. 2.

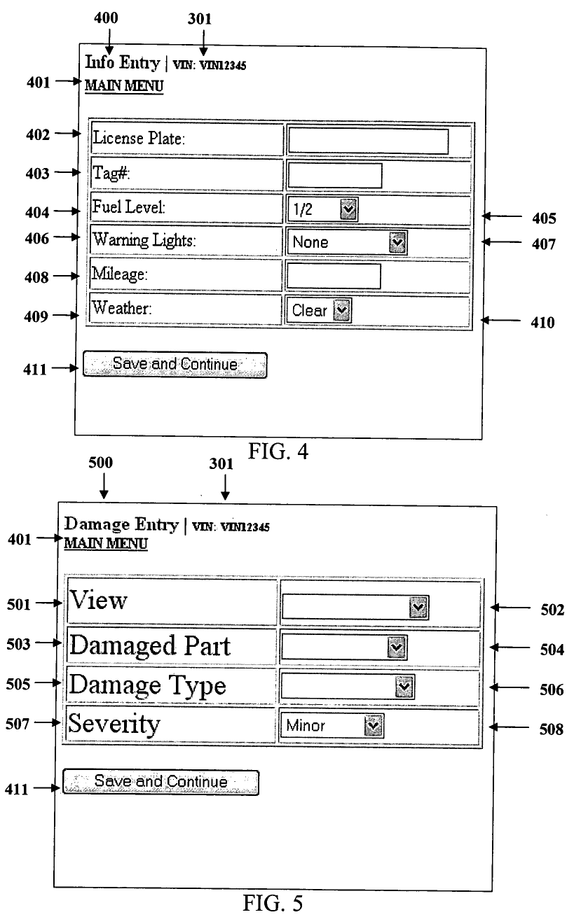

Referred to as the Info Entry screen, the “Plate, Mileage, and Tag Entry” form is accessible from the main menu via link 304, and allows the user to input static data about the vehicle. To obtain the required information, the user “starts” the vehicle and enters the data accordingly. A sample Info Entry screen is depicted in FIG. 4. The “Info Entry” icon 400 is shown in the upper left corner of the screen next to the vehicle identification number 301. A link 401 can be accessed to return the user to the main menu. License Plate and Dealer assigned tag information are entered along with other basic information about the vehicle. The user enters the license plate information in field 402. The vehicle tag number is entered into field 403. To indicate the Fuel Level 404, the user accesses pull-down menu 405 to select the approximate 15 amount of fuel (e.g. ½) present in the vehicle's gas tank at check-in.

The existence of Warning Lights 406 on the dashboard is selected from pull-down menu 407. The user inputs the current mileage, as displayed on the vehicle's odometer, into field 408. The weather conditions 409 are selected from pull-down menu 410. The conditions under which the images are captured should always be entered by the user to assist future image review by the user. To save the entries, the user taps the ‘Save and Continue’ button 411. This will store the entries and return the text data input device to the main menu. If the ‘MAIN MENU’ link 401 is selected without first choosing ‘Save and Continue’ 411, the information entered will be “ignored” and lost.

The next stage is to visually inspect the vehicle and complete Damage Entry screens. The user accesses the Damage Entry screen using The “Damage Entry” button 305 in FIG. 3. The process of damage entry is shown in FIGS. 5 through 11. In the preferred embodiment the service representative takes a photo of the front of the vehicle including the bumper, grilles, lights, etc. Optionally a shot of the front hood/windshield is included. As the service representative exits the vehicle, he checks the edge of the door panel for tears from the seat belt getting caught in the door. Optionally photos of the interior are also captured.

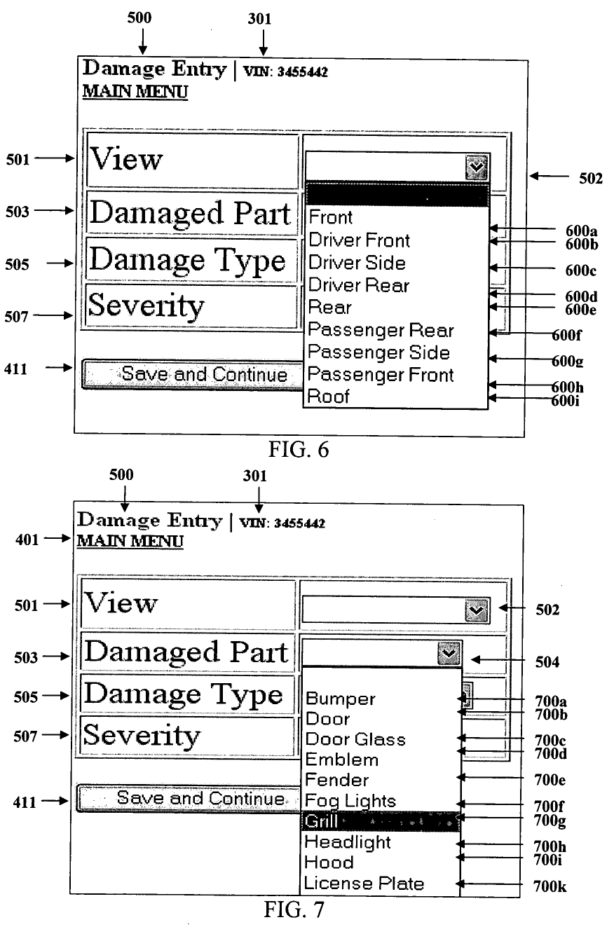

Using the pull-down menus on the Damage Entry screen, illustrated in FIG. 5, the user chooses a View 501, Damaged Part 503, Damage Type 505 and Severity 507 for each event recorded. This information is selected from menus 502, 504, 506, and 508, respectively. FIG. 6 depicts the pull-down menu 502 for the View 501 of the car that is depicted in the captured image, as entered by the user. The user may select from several options, including but not limited to Front 600a, Driver Front 600b, Driver Side 600c, Driver Rear 600d, Rear 600e, Passenger Rear 600f, Passenger Side 600g, Passenger Front 600h, and Roof 600i.

In the preferred embodiment, as the check-in process progresses, the service representative moves toward the drivers' side of the vehicle and photographs the front quarter panel, including tire and rim. (It is to be understood that in the alternative embodiment in which a dedicated capture zone is used (see below), all or most images are captured simultaneously.) Subsequently, photographs of the door/doors, and rear quarter panel and rim/tire are captured. The entire rear of the vehicle is captured. Similar images are captured from the passenger side of the vehicle. Images of the roof are also taken. It is recommended to position the camera at a slight angle to dramatically minimize glare and reveal additional damage.

An alternative embodiment uses a dedicated capture zone with plural cameras installed in protective enclosures. Optionally trigger switches for the cameras can be provided by either LEDs that send capture commands to the installed cameras through Wi-Fi or network cable. In the capture zone, after reading of the RFID or barcode tag, images of the vehicle are automatically taken and the system combines RFID or barcode ID data and images that are capable of displaying both summary and image zoom options to the authenticated host server users. Images and tag ID data are stored on the local client server for recall by any authenticated user on the local LAN network.

At approach to the capture zone, either the manually operated text input device, the RIFD transceiver, or the wireless barcode reader sends identification information to the server. After or simultaneously with identification, the vehicle enters the capture zone and, e.g., an installed LED switch sends trigger commands through the server to the installed cameras. Images are captured and matched up with vehicle identification information obtained as described above.

Either when the digital images are taken manually or when they are captured automatically in a capture zone, the resolution of the images preferably is high enough to facilitate zooming in access mode. Additionally, more detailed images are preferably shot of known damage zones.

As the vehicle is being inspected and photographed, items of needed work such as body work, windshield replacement, ding and rim repair, tires, are noted on the text data input device Damage Screen. If they are entered as “Major or Needs Attention” the system highlights the entry on the advisors screen to inform them that there are potential sale or safety issues. When body damage is noted, extra photos will be shot to allow body shops and insurance companies to estimate repairs from the photos alone.

FIG. 7 depicts the pull-down menu 504 for the Damaged Part 503 of the car that is the depicted in the captured image, as entered by the user. The user may select from several options, including but not limited to Bumper 700a, Door 700b, Door Glass 700c, Emblem 700d, Fender 700e, Fog Lights 700f, Grill 700g, Headlight 700h, Hood 700j, and License Plate 700k.

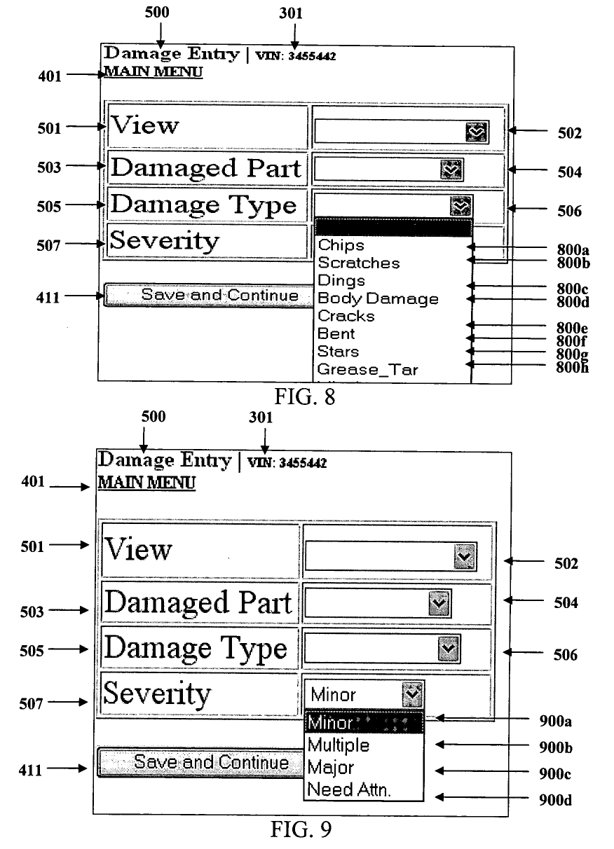

FIG. 8 similarly presents an exemplary text data input device screen shot of the pull-down menu 506 for the Damaged Type 505 of the car that is the depicted in the captured image, as entered by the user. The user may select from several options, including but not limited to Chips 800a, Scratches 800b, Dings, 800c, Body Damage 800d, Cracks 800e, Bent 800f, Stars 800g, and Grease/Tar 800h. FIG. 9 depicts the pull-down menu 508 for the Severity 507 of the car that is the depicted in the captured image, as entered by the user. The user may select from several options, including but not limited to Minor 900a, Multiple 900b, Major 900c, and Needs Attention 900d. To save these entries and return to the Damage Entry screen, the user activates the ‘Save and Continue’ button 411.

The system can retain multiple events for each vehicle. A good example would be that image and identification information are captured and stored for the same vehicle at both check-in and check-out. These multiple events are accessible in recall under conditions discussed below.

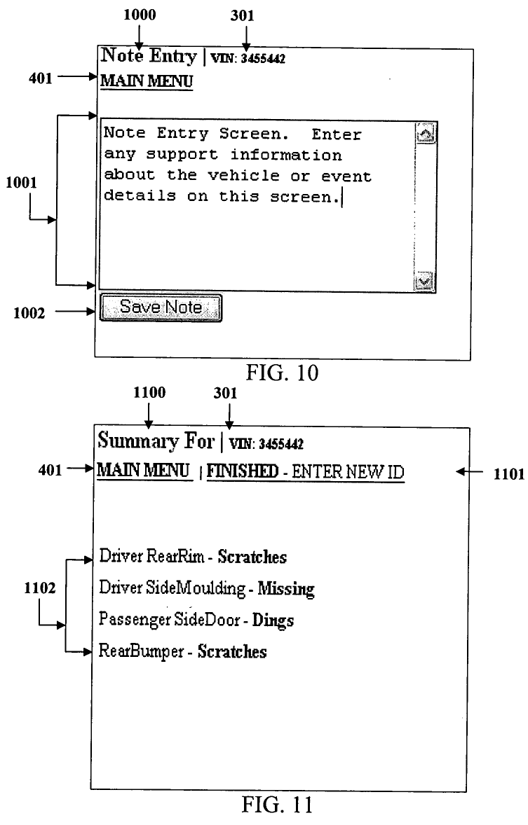

Upon return to the Main Menu, as depicted in FIG. 3, the user may select the ‘Note Entry’ link 306 to input support information or event details about the vehicle and the vehicle's damage into the system. The Note Entry screen is illustrated in FIG. 10, wherein the ‘Note Entry’ icon 1000 is set in the upper left corner of the screen. The user may enter the desired information into ‘Note Entry’ screen 1001. The user then taps the ‘Save Note’ button 1002, and may click the Main Menu link 401 to return to said menu.

At the bottom of the Main Menu screen, depicted in FIG. 3, is link 307, which provides the user with access to a ‘Summary’. The Summary screen, illustrated in FIG. 11, provides the user with a list of details 1102, providing the status of the vehicle at the time of check-in, as entered into the system by the user. As an example, FIG. 11 illustrates a Summary 1100 for VIN 3455442 that indicates that said vehicle was checked into the dealership with scratches on the driver's rear rim, a missing driver side moulding, dings on the passenger side door, and scratches on the rear bumper. Once the user has reviewed the summary information, he or she may access the Main Menu via link 401 or may select the ‘Finished—Enter New ID’ link 1101 to begin entering or reviewing information pertaining to another vehicle ID.

Images and data are then available for recall by authorized users of the system on any local workstation or handheld device or over the internet. The recall system is a collection of preconfigured computer screens that provide to the user authentication, redirection, and access to data and images captured by the locally installed system servers. Optionally, in the sub-embodiment in which the system uses the internet in whole or in part for communication, the preconfigured computer screens are web pages. In the internet sub-embodiment, recall is available to authenticated users via the internet.

In this internet sub-embodiment, the user logs onto an autocheckmate.com web site. The user is prompted for a user name and password for further access. The user is validated against the global server database, and after validation, is directed to the local server at a location registered during user setup. The validation database contains the name and URL of the local server to direct the user to the appropriate location.

In an alternative embodiment, instead of being stored locally, all data are sent to a public autocheckmate.com server. The wireless text data input device or a device located in the capture zone communicates with the public server through an on-site wireless access point optionally connected to the dealership LAN. In this version, the internet can be used for information input as well as retrieval. For example, in addition to simple handheld devices operating locally, the system can use for text data input a web-enabled text data input device, e.g., a cell phone capable of direct internet access. Other other web-enabled devices, such as a Blackberry™, can be used as well to e-mail text information to the system.

Once the authenticated member is connected to the local sever, the member is again authenticated against the local server database to determine the privilege level and access permission level for the local server programs, data and images. The local server has a series of screens that facilitate access to the local database. Reports are available to sort the wireless input device captured data by various fields, e.g. date, capture event ID, capture event condition issues, etc. Authenticated users can pull up capture event details, and all digital images that had metadata capture date and times within the same timeframe of the data associated with the capture event.

In either the internet sub-embodiment or the local area network sub-embodiment of the invention, digital images are first displayed along with capture event data in thumbnail mode. Capture event details along with digital images associated with the event can be viewed on or printed to a local terminal, hand held device, or printer. In addition, in either sub-embodiment, the user can open the thumbnail image in a third-party image viewer program. The user can use the viewer to further examine the high-resolution images in greater detail since a typical viewer supports pan, zoom and scroll. In the internet sub-embodiment, the third-party image viewer is implemented using java-based commands.

A Vendor Module facilitates access to the data by dealership vendors, for example, paint and part suppliers, aftermarket windshield suppliers, and the like. A vendor logs onto the main AutoCheckMate.com global server and provides authentication. The vendor then has access to pre-defined subsets of data of events. The vendor has a collection of screens which allow organization of the summary data, including status options, notes, follow-up date ticklers, prospect and capture event specific data, etc.

Similar to the Vendor module, a Service Module allows organization of and access to information about incidents summarized by incident type. Along with access to incident detail, the service module provides for organization of summary data, with status options, notes, follow-up date ticklers, prospect & customer specific data, and the ability to view service-specific incidents for several locations in one screen.

Local administrators control access to the data by outside users through a series of computer screen pages that appear as web pages hosted on the local server. Users are assigned names and passwords, and are assigned privilege levels. These levels are examined during page recall to allow and prevent access to data based on privilege.

Users log onto a public autocheckmate.com site to retrieve VIN data and images. With the public server storage option enabled, images are pulled directly from the autocheckmate.com server when VINs are recalled. If the dealership uses the local storage option, data is recalled from the public autocheckmate.com server, and images are pulled from the local PC and combined to display on web pages served from the autocheckmate.com public server. Other screens, reports, etc. are essentially the same as described in previous embodiments of the system.

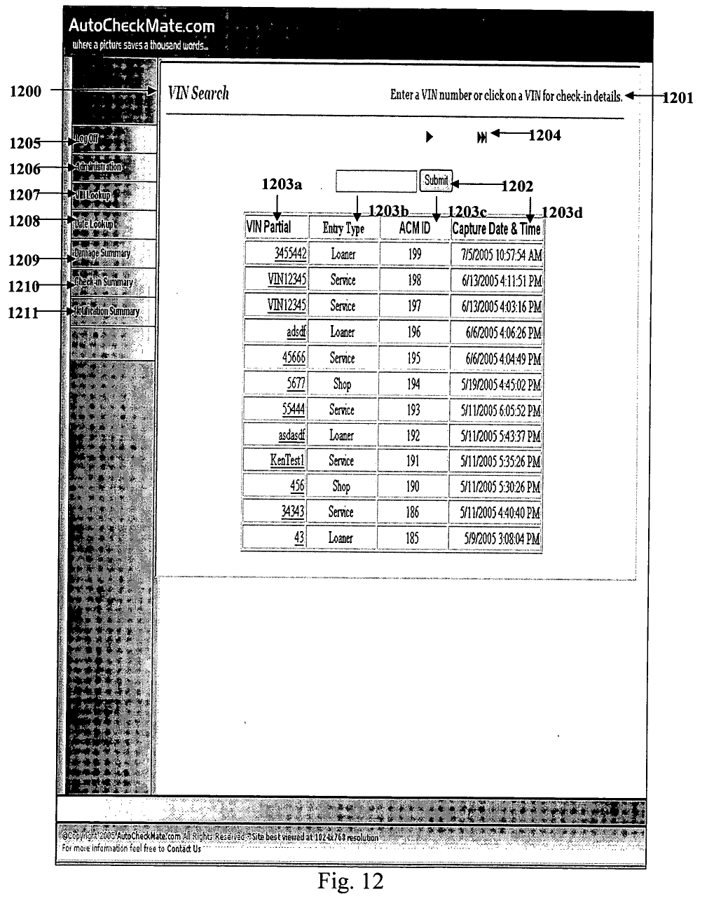

FIGS. 12 through 20 show screen shots of the public autocheckmate.com information retrieval subsystem. (Internal users can access substantially similar screens over hard wired or wirelessly connected terminals.) Once access to the system has been obtained via login, the user is presented with a menu on the left side of the screen shot through which links send the user to various parts of the autocheckmate.com website. The links include, but are not limited to functions such as “Log Off” 1205, “Administration” 1206, “VIN Lookup” 1207, “Date Lookup” 1208, “Damage Summary” 1209, “Check-in Summary” 1210 and “Notification Summary” 1211. FIG. 12 presents a VIN search screen, in which the title of said screen is found in the upper left corner of the screen shot as feature 1200. The system displays the VIN numbers to which the user has access. Instruction 1201 is presented in the upper right hand corner of the screen to notify the user to enter a VIN number in box 1202 or to click on the links in the “VIN Partial” column 1204a to obtain check-in details. The user may use the page forward buttons 1204 to move the through the pages of VIN records to which he or she has access. Column 1204b indicates the “Entry Type” of the vehicle. The “ACM ID” is indicated in column 1203c. The most recent “Capture Date and Time” is set forth in column 1204d.

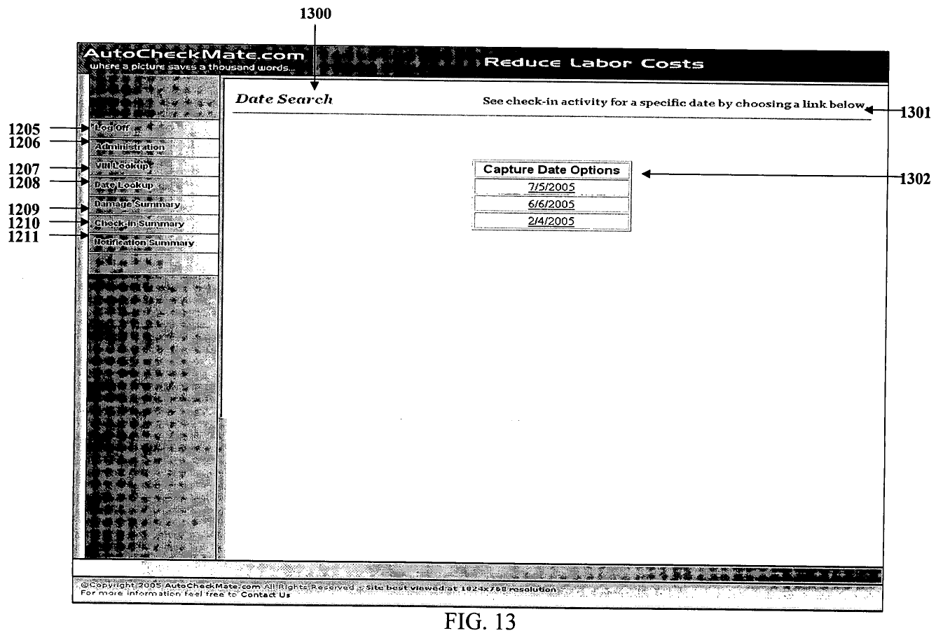

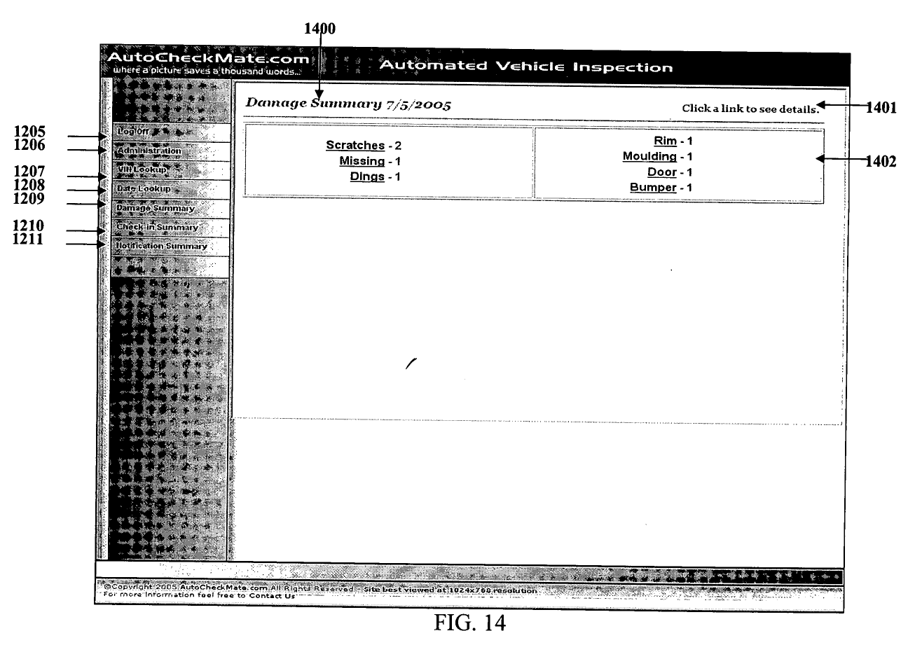

Upon selecting the “Date Lookup” link 1208 from the menu illustrated in FIG. 13, the user may view the “Date Search” 1300 screen. The user is instructed via notification 1301 to obtain access to the check-in details for a specific date by selecting a date link in column 1302, entitled “Capture Date Options”. For example, the user may select the link “7/25/2005” to progress to the “Damage Summary” 1209 screen for the particular date, as embodied in FIG. 14. The upper left hard corner indicates the title 1400 of the screen as “Damage Summary 7/25/2005” Instruction 1401 notifies the user to click on any of the links in area 1402 to obtain additional details. Links within 1402 may include damage indicator such as “Scratches”, “Missing”, “Dings”, “Rim”, “Moulding”, “Door”, and “Bumper”. Adjacent to each damage indicator is the number of occurrences or instances pertaining to the checked-in vehicle.

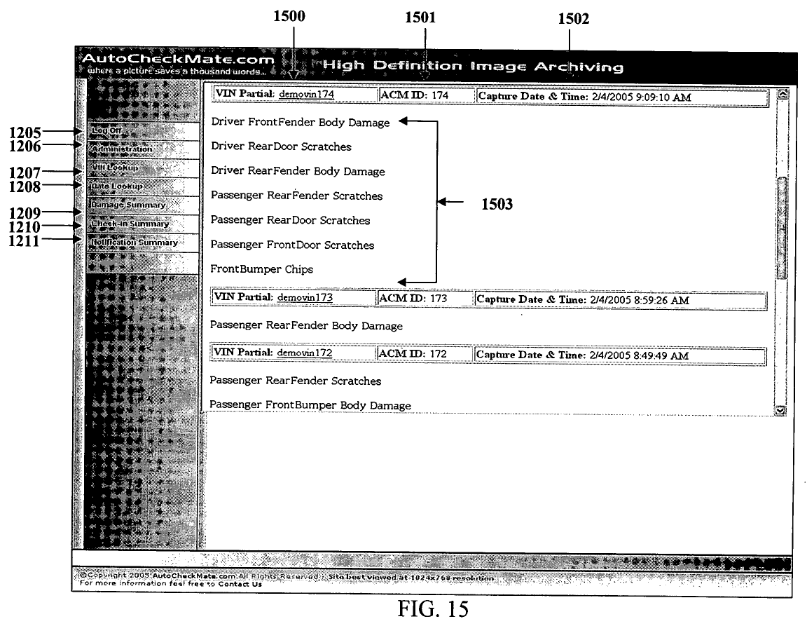

FIG. 15 illustrates a summary of vehicle damage organized by “VIN Partial” for each vehicle. The summary is accessed via the “Check-in Summary” link 1210. Sections 1500, 1501, and 1502 in the upper portion of the screen present the specific “VIN Partial”, “ACM ID” and “Capture Date and Time”, respectively. For VIN Partial demovin174, the check-in summary is presented in a data list 1503. Similar arrangements for additional summary details for other vehicles are presented in succession, as illustrated by the summaries for VIN Partial demovin173 and VIN Partial demovin172 as shown in FIG. 15.

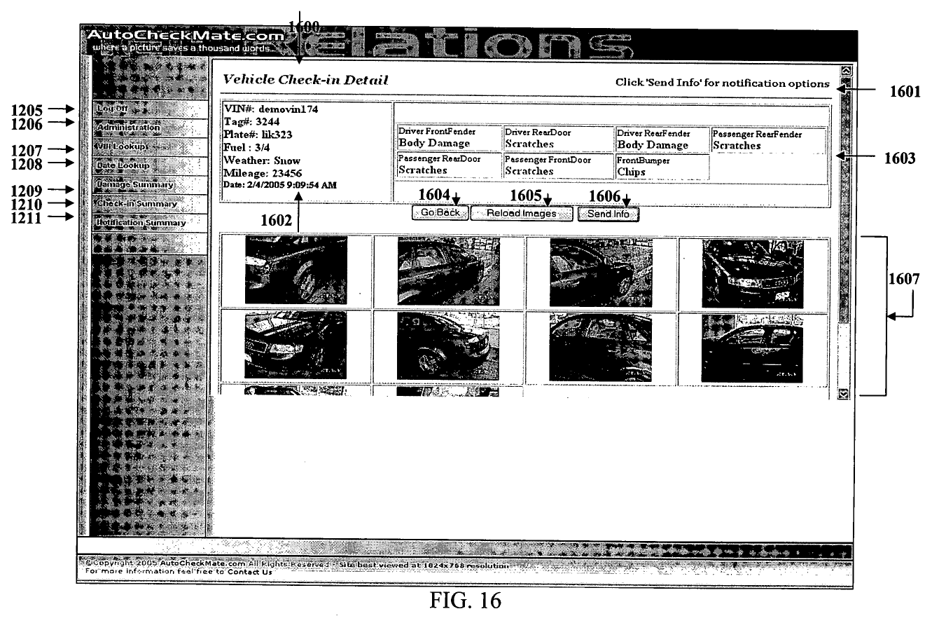

Vehicle Check-in Detail 1600 is illustrated in FIG. 16. Instruction 1601 directs the user to click the “Send Info” button 1606 to access the system's notification options. Section 1602 provides the user with the identification, and conditions data that was entered by the service representative upon check-in Section 1603 provides details of the type of damage present on each vehicle components listed. Buttons 1604, 1605, and 1606 are clicked by the user to “Go Back” to a previous page, “Reload Images” or “Send Info”, respectively. Images of the vehicle's components taken on the date of check-in are portrayed in picture thumbnails 1607 of FIG. 16. The screen allows the user to scroll down to obtain viewing access to all of the images taken for the pertinent vehicle.

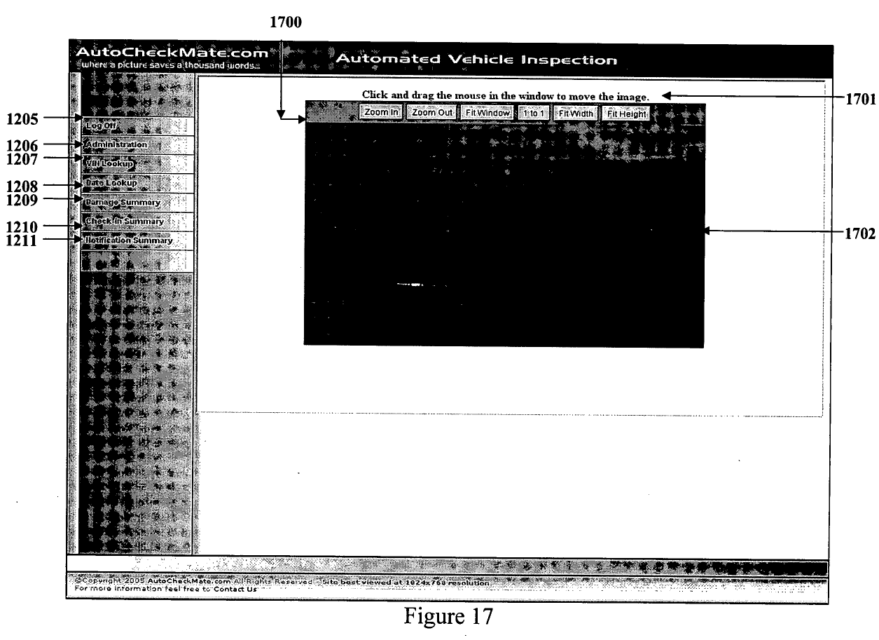

The system uses off-the-shelf image viewing software. By clicking on any of the images presented in thumbnails 1607, the user may view a close-up of the selected image, as illustrated in FIG. 17. Again using off-the-shelf image viewing software, navigation menu 1700 allows the user to select the preferred viewing area by way of a number of buttons, including “Zoom In”, “Zoom Out”, “Fit Window”, “1 to 1”, “Fit Width” and “Fit Height”. By dragging the computer terminal's mouse or text data input device stylus within the viewing window 1702, the user is able to move the image, as set forth in instruction 1701. Zooming in permits close inspection of, e.g., damage areas, and preferably adjacent images have been shot to facilitate understanding of damage and estimation of repair needs and cost.

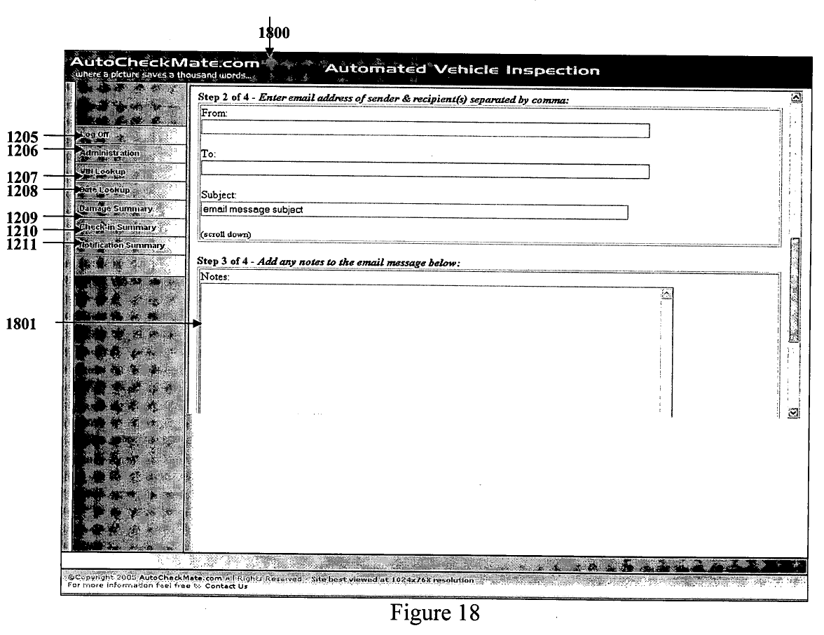

The electronic mail notification feature of the inventive system is illustrated in FIG. 18. By clicking the “Send Info” button 1606 in FIG. 16, the user is directed to Notification Screen 1800 to send notes and information to desired parties about the check-in details of the pertinent vehicle. Notification Screen 1800 contains “From”, “To”, and “Subject” fields for the user's input. Note screen segment 1801 presents an area in which the user may compose any notations about the particular vehicle.

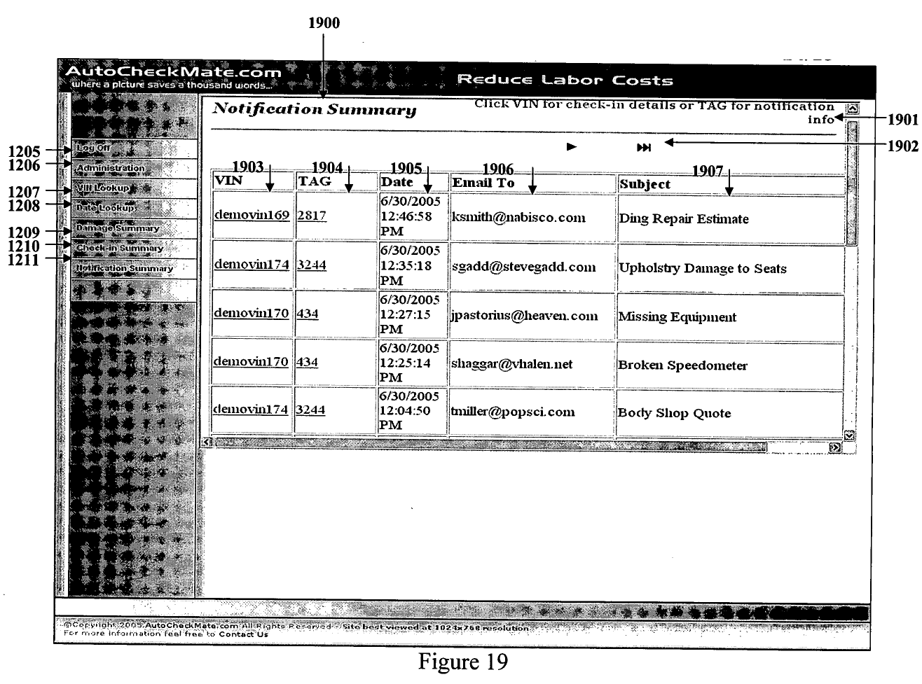

The Notification Summary screen 1900, accessed via menu button 1211, is exemplified in FIG. 19. Notification 1901 instructs the user to click on the desired VIN in column 1903 to obtain check-in details, or to click on the desired TAG in the TAG column 1904 for notification information. Column 1905 presents the date and time when each electronic mail notification was sent. The recipient of the electronic mail notification is identified in column 1906. The subject line of the electronic mail notification is presented in column 1907. The user may scroll down using scrolling arrow 1902 to view additional notification details presented on the Notification Summary screen 1900.

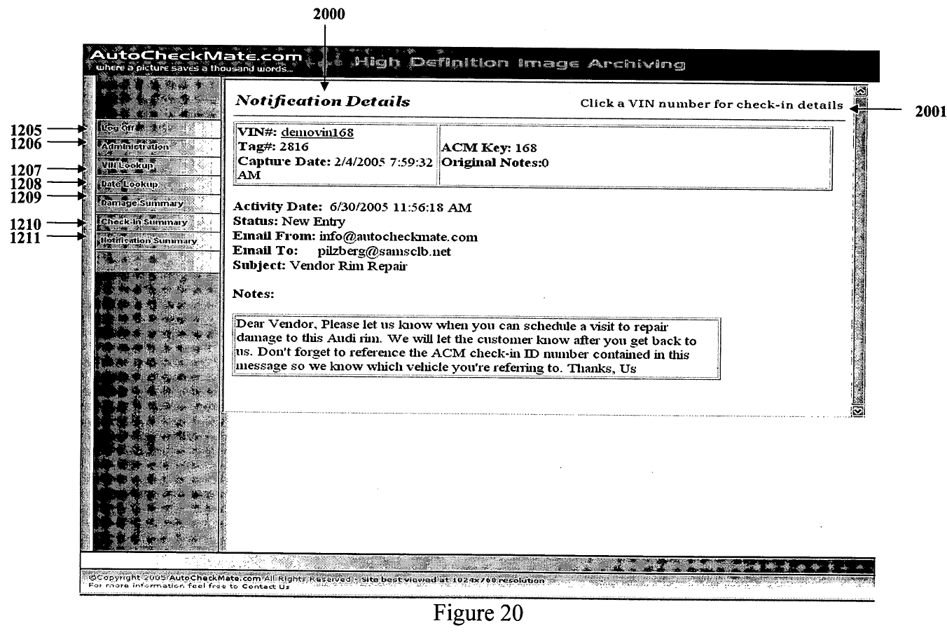

An exemplary screen shot of the Notification Details screen 2000 is presented in FIG. 20. Notification 2001 instructs the user to click on the VIN to review the check-in details. In FIG. 20, the VIN is located in the upper left segment of the screen with the remainder of the identification details for the pertinent vehicle. The details of the electronic mail notification for this VIN are set forth in the main body of the screen 2000. The display functionality, features and reporting screens and options are similarly present in subsequent embodiments of the inventive system.

We claim:

1. An automated vehicle image and data documentation system comprising:
a) a computer server configured to store linked vehicle identification data and image data;
b) software configured to store in retrievable fashion linked vehicle identification data and image data;
c) at least one apparatus capturing a vehicle image;
d) at least one identifying text data input device;
e) at least one data retrieval apparatus; and
f) a linking network configured to link said computer server with said at least one vehicle image capture device, at least one identifying text data input device, and at least one data retrieval apparatus.

2. The system of claim 1 wherein said software is a database management system and the information is stored in a database.

3. The system of claim 1 wherein the image capture apparatus comprises at least one digital camera.

4. The system of claim 1 wherein the image capture apparatus comprises a capture zone comprising at least a plurality of digital image capture devices.

5. The system of claim 1 wherein the at least one identifying text data input device comprises a handheld text input device.

6. The system of claim 5 wherein the handheld text input device is selected from the group consisting of: personal digital assistant, text-capable cell phone, remote e-mail device.

7. The system of claim 1 wherein the at least one data retrieval apparatus comprises a personal computer.

8. The system of claim 1 wherein the linking network comprises a wi-fi network.

9. The system of claim 1 wherein the linking network comprises the internet.

10. The system of claim 1 in which the at least one vehicle image capture apparatus additionally comprises a subsystem that captures date and time information.

11. The system of claim 7 wherein the at least one data retrieval apparatus connects to the server via the internet.

12. The system of claim 1 wherein the image capture resolution is sufficient to permit image zooming during image viewing.

13. A method of documenting and retrieving vehicle condition comprising:
a) entering vehicle identification information;
b) capturing at least one digital image of the vehicle;
c) capturing date and time information to be associated with the at least one digital image;
d) associating the vehicle identification information with the at least one digital image and with the date and time information;
e) storing the vehicle identification information, the at least one digital information, and the date time information in a database located on the server; and
f) accessing the stored vehicle information via a linking network on at least one data retrieval apparatus.

14. The method of claim 13 wherein the method of documenting and retrieving vehicle condition information operates at least in part over the internet.

15. The method of claim 13 wherein entering vehicle identification information comprises reading pre-coded information from a tag associated with the vehicle comprising an information carrying device selected from the group: bar code sticker, RFID tag.

16. The method of claim 13 additionally comprises the step of viewing stored vehicle images.

17. The method of claim 16 wherein the step of viewing stored images additionally comprises the substep of zooming on at least one stored image.
